(19) United States
(12) Patent Application Publication
(10) Pub. No.: US 2006/0105741 A1
(43) Pub. Date: May 18, 2006

(54) Method and apparatus for security of IP security tunnel using public key infrastructure in mobile communication network

(75) Inventors: Dong-Wook Suh, Seongnam-si (KR); Se-Hun Hwang, Seongnam-si (KR); Bok-Jin Moon, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/281,677

(22) Filed: Nov. 18, 2005

(30) Foreign Application Priority Data
Nov. 18, 2004 (KR) 10-2004-0094646

(51) Int. Cl. H04M 3/16

(52) U.S. Cl. 455/410

(57) ABSTRACT

A method and apparatus is provided for security of an IP security tunnel using public key infrastructure, including the steps of receiving a request message which relates to a security service requested by a mobile node, determining if there is security association (SA) for the security service and determining if there is a public key related to a peer address when the SA does not exist, sending a certificate request message to a certificate authority (CA) when the public key does not exist and receiving a certificate response message which has a certificate that includes a public key. The method further includes the steps of performing an internet key exchange and SA establishment procedure with a peer corresponding to the peer address by using the certificate, completing the internet key exchange and the SA establishment, and encrypting a packet received from the mobile node, transmitting the encrypted packet to the peer, decrypting a packet received from the peer, and transmitting the decrypted packet to the mobile node.

### CROSS-REFERENCE TO RELATED APPLICATION

This application claims the benefit under 35 U.S.C. §119(a) of Korean Patent Application No. 10-2004-0094646 entitled “Method And Apparatus For Security Of IP Security Tunnel Using Public Key Infrastructure In Mobile Communication Network” filed in the Korean Intellectual Property Office on Nov. 18, 2004, the entire disclosure of which is incorporated herein by reference.

### BACKGROUND OF THE INVENTION

1. Field of the Invention

The present invention relates to a mobile communication system in the Internet. More particularly, the present invention relates to a method and apparatus for using public key infrastructure (PKI) for secret management which is used to create security association (SA) information of an Internet Protocol security (IPsec) tunnel.

2. Description of the Related Art

In general, when a mobile node (terminal) desires to receive an IP security service in a UMTS or CDMA2000 core network, two types of modes may be used. The first mode is a transport mode in which an IPsec tunnel is created between a mobile node and a peer (i.e. a counterpart node). Herein, the peer may be a bank server to which the mobile node desires connection, or a security-required host. The second mode is a tunnel mode in which either a gateway GPRS support node (GGSN) in a UMTS network or a packet data support node (PDSN) in a CDMA core network serves as a security gateway. In this mode, an IPsec tunnel is created between the security gateway and a remote security node (i.e. a peer). Generally, due to the lack of processing power of a mobile node, the tunnel mode using the security gateway is typically used.

In the tunnel mode, SA negotiation is required to create an IPsec tunnel between nodes. In this case, a secret key is used for nodes to verify each other, and a procedure of exchanging such a secret key is called internet key exchange (IKE). In the IKE procedure, a secret key is obtained using one of two schemes. The first scheme is a shared secret key scheme, in which each node obtains the same key through a predetermined route and than an IKE procedure is performed using the obtained key. The second scheme is a public key infrastructure (PKI) scheme. According to the PKI scheme, each node creates a public key which is to be made open to the public and a private key to be held privately by each node itself, and registers the public key in a credible certificate authority (CA). After this, a sender establishes SA with a peer by using a peer's public key obtained from the CA, instead of using a shared secret key. The scheme using a public key has advantages in that key management is facilitated and the security of a key can be improved.

The following description will be given with respect to a GGSN in a UMTS core network. Alternatively, a PDSN in a CDMA2000 core network may be used instead of the GGSN.

FIG. 1 is a view illustrating a structure of a conventional network in which the GGSN uses a shared secret key.

In a UMTS network, a GGSN 100 is connected with a plurality of peers 110 to 130, which need a security service. In order to provide a security service to the mobile nodes 140 and 150, the GGSN 100 establishes SA with each of the peers 110 to 130 to create an IPsec tunnel. The GGSN 100 uses different secret keys for every SA establishment. When shared secret keys are used for SA between the GGSN 100 and the peers 110 to 130, the GGSN 100 must manage different secret keys for every IPsec tunnel, and must manually change the value of a key together with a node whenever the secret key related to the relevant node is changed. In addition, in this case, a scheme for sharing the changed shared secret key must be established.

According to the conventional network as described above, when a pre-shared key (PSK) scheme (i.e. a shared secret key scheme) is used for SA establishment with a large number of IP security nodes in the UMTS network, there is an inconvenience that the GGSN should manage keys according to SAs, and a difficulty lies in distributing PSKs. In addition, in this case, when a key is changed for the purpose of security, SA establishments must be changed together with the nodes according to SAs. Moreover, since a GGSN must manage the values of all keys related to nodes, it is difficult to automatically manage each of shared secret keys, thereby degrading the security of keys.

Accordingly, a need exists for a system and method for effectively and efficiently using public key infrastructure to obtain a public key in an internet key exchange procedure between a security gateway and a peer when a mobile node desires to receive a security service.

### SUMMARY OF THE INVENTION

Accordingly, the present invention has been made to substantially solve the above-mentioned and other problems, and the present invention provides a method and apparatus for supporting a function to use public key infrastructure (PKI) in order to obtain a public key in an internet key exchange (IKE) procedure between a security gateway and a peer when a mobile node desires to receive a security service.

Also, the present invention provides a method and apparatus for reducing the load imposed on a gateway GPRS support node (GGSN) or packet data support node (PDSN) for managing key values for each node by applying the PKI to secret management for an IPsec tunnel in the GGSN or PDSN.

In addition, the present invention provides a method and apparatus for enabling active management of secret keys by registering a changed public key in a certificate authority (CA) so that the CA can broadcast the changed public key or that a remote security node can ask the CA for the public key of a peer.

To this end, in accordance with one aspect of the present invention, a method is provided for security of an IP security tunnel using public key infrastructure in a security gateway of a mobile communication network, the method comprising the steps of receiving a request message which relates to a security service requested by a mobile node from the mobile node, determining if there is security association (SA) for the security service and determining if there is a public key related to a peer address when the SA does not exist, sending a certificate request message to a certificate authority (CA) when the public key does not exist and receiving a certificate response message which has a certificate that includes a public key related to the peer address from the certificate authority. The method further comprises the steps of performing an internet key exchange and SA establishment procedure with a peer corresponding to the peer address by using the certificate, completing the internet key exchange and the SA establishment, and encrypting a packet received from the mobile node by means of the public key, transmitting the encrypted packet to the peer, decrypting a packet received from the peer by means of a private key corresponding to the public key, and transmitting the decrypted packet to the mobile node.

In accordance with another aspect of the present invention, a method is provided for security of an IP security tunnel using public key infrastructure in a security gateway of a mobile communication network, the method comprising the steps of creating a tunnel in cooperation with a service node providing a service to a mobile node and receiving a packet having a security-required peer address through the created tunnel, buffering the received packet and determining if security association (SA) for the security-required peer address has been established, determining if there is a public key related to the peer address when the SA does not exist, sending a certificate request message to a certificate authority (CA) when the public key does not exist and receiving a certificate response message which has a certificate including a public key related to the peer address from the certificate authority. The method further comprises the steps of performing an internet key exchange and SA establishment procedure with a peer corresponding to the peer address by using the certificate, and encrypting a packet received from the mobile node by means of the public key to transmit the encrypted packet to the peer when the internet key exchange and the SA establishment are completed, and decrypting a packet received from the peer by means of a private key corresponding to the public key to transmit the decrypted packet to the mobile node.

In accordance with still another aspect of the present invention, a method is provided for security of an IP security tunnel using public key infrastructure in a mobile communication network, the method comprising the steps of creating, by a security gateway for a mobile node, a new key pair containing a public key and a private key in order to change public/private keys used to communicate with the mobile node and a peer and sending a key update request message including the new key pair to a certificate authority, storing, by the certificate authority, an existing certificate of the security gateway in a certification revocation list, creating a certificate response message having a new certificate including the new key pair, and transmitting the certificate response message to the security gateway. The method further comprises the steps of storing, by the security gateway, a pre-stored certificate in a certification revocation list of the security gateway, storing the new certificate, and then transmitting a confirmation message to the certificate authority and broadcasting, by the certificate authority, a certificate announcement message including the new certificate to authentication clients, which are managed by the certificate authority, in response to the confirmation message.

In accordance with still another aspect of the present invention, an apparatus is provided for security of an IP security tunnel using public key infrastructure in a security gateway of a mobile communication network, the apparatus comprising a mobile node for generating a request message related to a security service to transmit the request message to the security gateway and for transmitting/receiving packet data, and the security gateway for determining if there is security association (SA) for the security service, determining if there is a public key related to a peer address when the SA does not exist, sending a certificate request message to a certificate authority (CA) when the public key does not exist, and receiving a certificate response message which has a certificate including a public key related to the peer address from the certificate authority. The security gateway is further provided for performing an internet key exchange and SA establishment procedure with a peer corresponding to the peer address by using the certificate, encrypting a packet received from the mobile node by means of the public key, transmitting the encrypted packet to the peer when the internet key exchange and the SA establishment has been completed, decrypting a packet received from the peer by means of a private key corresponding to the public key, and transmitting the decrypted packet to the mobile node. The apparatus further comprises the certificate authority for transmitting a certificate response message, which has the certificate including the public key related to the peer address, to the security gateway when the certificate request message is received from the security gateway.

### BRIEF DESCRIPTION OF THE DRAWINGS

The above and other objects, features and advantages of the present invention will become more apparent from the following detailed description taken in conjunction with the accompanying drawings, in which:

FIG. 1 is a view illustrating a structure of a conventional network in which the GGSN uses a shared secret key;

FIG. 2 is a block diagram illustrating a structure of a network using PKI in order to provide a subscriber with an IP security service according to an exemplary embodiment of the present invention;

FIG. 3 is a flowchart illustrating an operational procedure in a UMTS network according to a first embodiment of the present invention;

FIG. 4 is a flowchart illustrating an operational procedure in a UMTS network according to a second embodiment of the present invention;

FIG. 5 is a flowchart illustrating an operational procedure in a CDMA network according to a third embodiment of the present invention;

FIG. 6 is a flowchart illustrating the operation of a GGSN according to the first and second embodiments of the present invention;

FIG. 7 is a flowchart illustrating the operation of a PDSN according to the third embodiment of the present invention;

FIG. 8 is a view illustrating an exemplary table related to a GGSN included in the GGSN according to an embodiment of the present invention;

FIG. 9 is a view illustrating an exemplary table related to peers included in the GGSN according to an embodiment of the present invention; and

FIG. 10 is a flowchart illustrating a procedure for changing a public/private key by a GGSN according to an embodiment of the present invention.

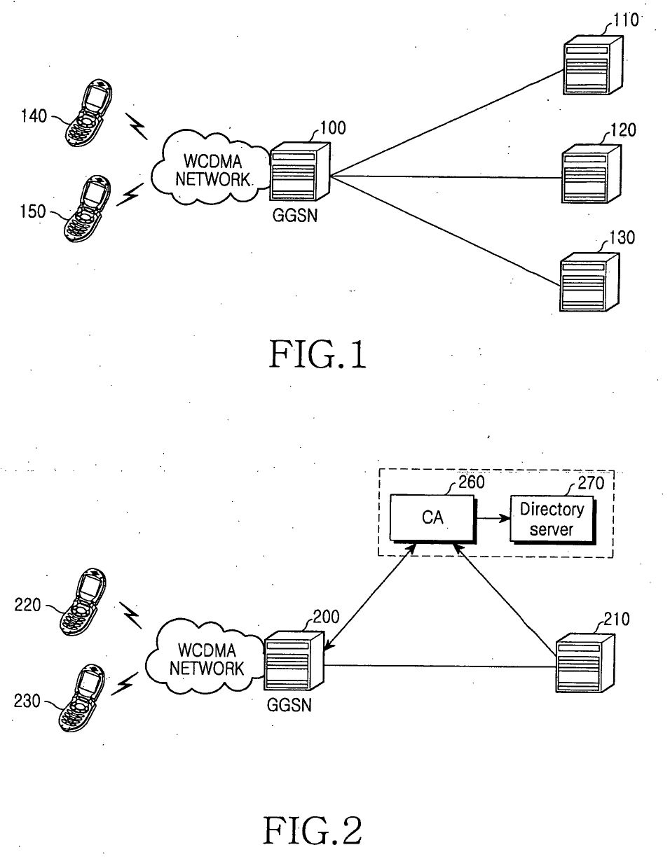

Throughout the drawings, like reference numerals will be understood to refer to like parts, components and structures.

### DETAILED DESCRIPTION OF THE EXEMPLARY EMBODIMENTS

Hereinafter, exemplary embodiments according to the present invention will be described with reference to the accompanying drawings. In the following description of the embodiments of the present invention, a detailed description of known functions and configurations incorporated herein will be omitted when it may obscure the subject matter of the present invention. In addition, the terminology used in the following description is defined in consideration of the function of corresponding components used in the present invention and may be varied according to users, operator's intention, or practices. Accordingly, the definition must be interpreted based on the overall content disclosed in the description.

Although embodiments of the present invention are described with respect to a gateway GPRS support node (GGSN) in a UMTS core network, the present invention is not limited thereto, and can be applied to a packet data support node (PDSN) in a CDMA2000 core network instead of the GGSN. Therefore, the following description separately describes details regarding only differences which are caused by the structural difference between the two nodes.

Embodiments of the present invention utilize public key infrastructure (PKI) for keys which is used in an internet key exchange (IKE) procedure in a security gateway in the Internet, thereby reducing the load imposed on the security gateway when managing key values according to nodes. Also, according to embodiments of the present invention, a changed public key is registered in a certificate authority (CA) so that the CA can broadcast the changed public key or a remote security node can acquire the public key of a peer by asking the CA for the public key, thereby enabling active management of secret keys.

The PKI refers to a complex security system environment to provide encryption and digital signature through public key algorithm. That is, the PKI refers to a scheme for encrypting transmission/reception data by using a public key including encryption and decryption keys and for authorizing a user through a digital certificate.

When a subscriber desires to receive an IP security service in a mobile communication system, the structure of a network using PKI instead of a shared key can be shown as in FIG. 2.

FIG. 2 is a block diagram illustrating a structure of a network using PKI in order to provide a subscriber with an IP security service according to an embodiment of the present invention.

In FIG. 2, the structure of a network using the PKI is illustrated with respect to the case in which a GGSN serves as a security gateway for a mobile node in a UMTS. A UMTS network interworks with a CA 260 for managing public keys, a directory server 270 for managing and storing certificates and a certification revocation list (CRL), and a GGSN 200 for operating as a security gateway for mobile nodes 220 and 230, as well as for serving as a certificate client to generate a certificate request. The directory server 270 may be included in the CA 260, so the following description will be given with respect to the case in which the CA 260 includes the directory server 270.

In order to provide a security service to the mobile nodes 220 and 230, the GGSN 200 establishes SA with a peer 210 to create an IPsec tunnel, and a secret key is used upon generation of the SA. In the case in which a shared secret key is used to generate SA between the GGSN 200 and the peer 210, when the GGSN 200 registers a public key in the CA 260, a security key can be actively managed in such a manner that the CA 260 broadcasts the public key or such that remote security nodes 220 and 230 can ask the CA 260 for the public key of the peer 210.

In order to implement an exemplary embodiment of the present invention, it is preferable to consider steps sequentially applied to the GGSN by using PKI, procedures performed when the GGSN changes a public/private key, and definitions of a table which must be managed by the GGSN, each of which will now be described.

First, when PKI is applied to the GGSN, if the PKI is used for the IKE procedure, the GGSN must support six steps as follows.

A first step comprises “Enrollment”. An enrollment operation for registering a public key of a mobile node in a CA with respect to an IP address of the mobile node is required in order to use PKI. To this end, a GGSN creates a public/private key with respect to its own interface IP address and stores the public/private key in a security table. Herein, since the GGSN is interfaced with the CA, the GGSN can exchange messages with the CA.

A second step comprises “Certificate Request/Response”. When desiring to establish SA with a peer, the GGSN transmits a certificate request message to the CA in order to obtain a public key of the peer. The schemes for transmitting a certificate request message by the GGSN in an IKE procedure using the PKI may be classified into three schemes according to transmission time as described below.

1) When a manager requests a certificate, a certificate request message is transmitted according to the operation of the manager, regardless of whether a call is made or not;

2) A certificate request message is transmitted when a Create Packet Data Protocol Context request (CPCRQ) message having a specific access point name (APN) is received. Herein, a specific IP security service is defined with an APN. When a mobile node uploads a call using the APN in order to be provided with the security service, a serving GPRS support node (SGSN) having received the call carries the APN to the GGSN by the CPCRQ message. When the GGSN receives the CPCRQ message, the GGSN determines whether or not SA for the APN exists. The GGSN sends an authentication request to the CA when SA for the APN does not exist; and

3) When a packet transmitted by a mobile node matches an access control list (ACL) after a GPRS tunneling protocol (GTP) tunnel is created, an authentication request is sent. Herein, ACL refers to a list of security-required peer addresses established so as to inform the GGSN of each user's authority capable of accessing each specific system entity, such as a directory or file. Therefore, when a packet matches the ACL, it means that the peer address of the packet is included in the ACL. For instance, this third scheme may be used when the user of the mobile node desires to do mobile banking on the Internet.

The second and third schemes show different cases depending on whether a security service is based on APNs or based on packet's security node addresses. That is, the second scheme matches a single GTP tunnel with a signal security tunnel, while the third scheme may match a single GTP tunnel with a plurality of security tunnels for a security service.

A third step comprises “Internet Key Exchange (IKE) Establishment”. The IKE establishment is achieved through an authentication step, and an internet security association and key management protocol (ISAKMP) SA generating step. In the authentication step, the GGSN sends data (i.e. ISAKMP policy information of the GGSN) for authentication to a peer. The ISAKMP policy information refers to a framework to define a payload for the procedure for establishment, negotiation, change, and deletion of SA, a packet's format, key creation, and exchange of authenticated data.

The peer determines whether or not ISAKMP policy information exists in a table in relation to the GGSN. When the ISAKMP policy information does not exist, the peer sends a certificate request for a GGSN address to the CA. Then, the peer receives a certificate, which includes ID, a public key of the GGSN, a digital signature, and ISAKMP policy, for the GGSN from the CA, and determines whether or not the information received from the CA is identical to ISAKMP policy information received from the GGSN. In contrast, when the ISAKMP policy information exists, the peer determines whether or not the existing information is identical to ISAKMP policy information received from the GGSN. As a result of the determination, if compared information is identical to each other, the peer outputs an “ACK” signal, but if not, the peer outputs a “NACK” signal. After this, IPsec policy information, such as a certificate, is exchanged between the GGSN and the peer. In the ISAKMP SA generating step, ISAKMP SA is generated according to ISAKMP policy negotiation.

A fourth step comprises “SA Establishment”. The SA is established by performing negotiation for SA establishment by means of the ISAKMP policy information exchanged through IKE establishment.

A fifth step comprises “Encryption of Packet”. Encryption of a packet may be classified into two cases, as described below, according to whether or not a key update (re-key) function is provided. In the case where the key update function is not used, data is encrypted using a public key stored in a GGSN's table after SA has been established. In the case where the key update function is used, encryption/decryption is performed by using a session key created by the GGSN, rather than using a public/private key. Then, a key update procedure is performed after the lifetime for the security of a security tunnel elapses.

When a session key is used for the encryption/decryption in the key update procedure, it is possible to strengthen the security of an IP security tunnel through the key update procedure without changing the key-pair. An exemplary key update procedure is as follows.

In step A, traffic volume is generated or a lifetime is ended.

In step B, the GGSN creates a session key and performs a new IKE negotiation procedure.

In step C, an authentication procedure and an ISAKMP SA establishment are performed.

In step D, negotiation for IPsec policy is performed using the established ISAKMP SA.

In step E, new SA is created through the IPsec negotiation and a lifetime is initialized.

A sixth step comprises “Decryption of the Encrypted packet”. When a public/private key is used, a peer decrypts the encrypted data received from the GGSN by means of a private key of the peer. In order to send data to the GGSN, the peer encrypts data by means of a public key of the GGSN, which has been received from the CA and stored in a table.

When a session key is used, the peer stores a session key received from the GGSN in an SA procedure, and decrypts the encrypted data received from the GGSN by means of the stored session key.

Hereinafter, a procedure for applying PKI to a GGSN will be described with various exemplary embodiments of the present invention.

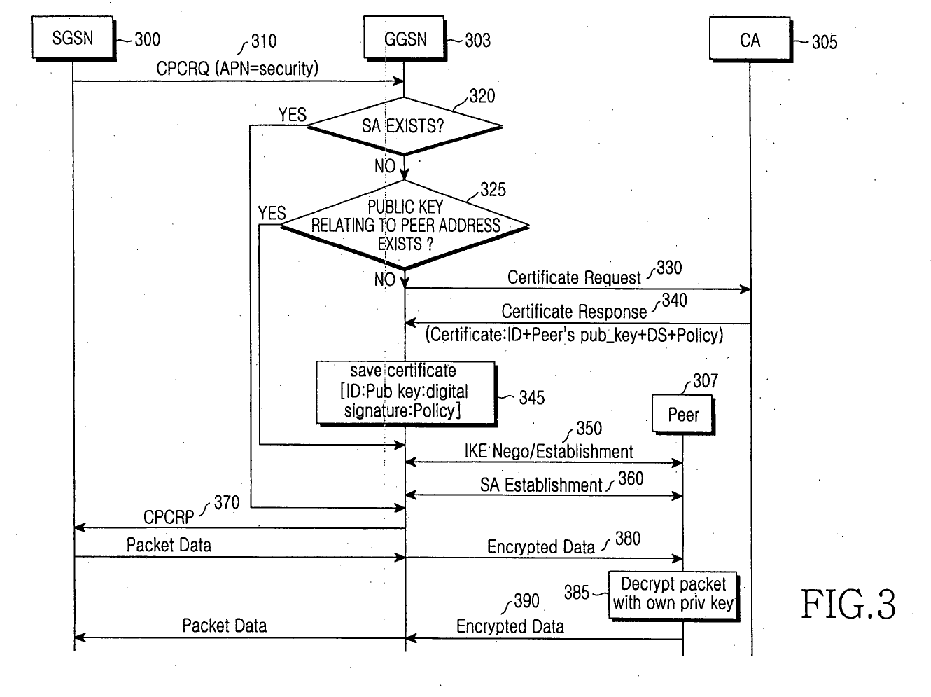

FIG. 3 is a flowchart illustrating an operational procedure in a UMTS network according to a first embodiment of the present invention. That is, FIG. 3 shows the case in which a GGSN requests a certificate without using a key update function when the GGSN receives a CPCRQ including a specific APN.

In the method illustrated in FIG. 3, a mobile node attempts a call to an APN (security) related to a specific security service through an SSGN in order to receive the specific security service. In step 310, the SGSN 300 sends a CPCRQ message including the APN (security) to a GGSN 303. In step 320, the GGSN 303 determines whether or not SA for the APN exists. If SA for the APN exists, the GGSN 303 proceeds to step 370.

In contrast, if SA for the APN does not exist, the GGSN 303 proceeds to step 325, in which the GGSN 303 determines whether or not a public key related to a peer address exists in a pre-stored security table. If a public key related to the peer address exists, step 350 is performed. If a public key related to the peer address does not exist, the GGSN 303 proceeds to step 330 to send a certificate request message to a CA 305. In this case, consistency of the contents (i.e. the public key related to the peer address) stored in the CA 305 and the contents stored in the GGSN 303 preferably must be guaranteed.

In step 340, the GGSN 303 receives a certificate response message having a certificate, which includes a digital signature, an IPsec policy, an identifier, and a public key of the peer, from the CA 305. In step 345, the GGSN 303 stores the received certificate, which includes information about the digital signature, the IPsec policy, the identifier, and the public key of the peer in the security table.

In step 350, the GGSN 303 initiates an IKE procedure with the peer 307 by using the public key and IP security policy information stored in the security table. After the IKE procedure is finished, the GGSN 303 initiates the SA establishing procedure with the peer 307 in step 360. When the SA establishment has been completed in step 360, the GGSN 303 proceeds to step 370, in which the GGSN 303 sends a Create Packet Data Protocol Context Response (CPCRP) message to the SGSN 300. If the SA establishment fails in step 360, the reason for failure (e.g., service not supported) is recorded in a cause field of the CPCRP message, and then the CPCRP message is transmitted to the SGSN 300.

In step 380, the GGSN 303 encrypts a packet transmitted from the mobile node by using the peer's public key stored in the security table, and sends the encrypted packet to the peer 307.

In step 385, the peer 307 having received the encrypted packet decrypts the encrypted packet by means of its own private key. In step 390, in order to send data to the mobile node, the peer 307 encrypts the data by using the public key of the GGSN 303 stored in a table of the peer 307, and then sends the encrypted data to the GGSN 303. Then, the GGSN 303 decrypts the encrypted data transmitted from the peer 307, and transmits the decrypted data to the mobile node through the SGSN 300.

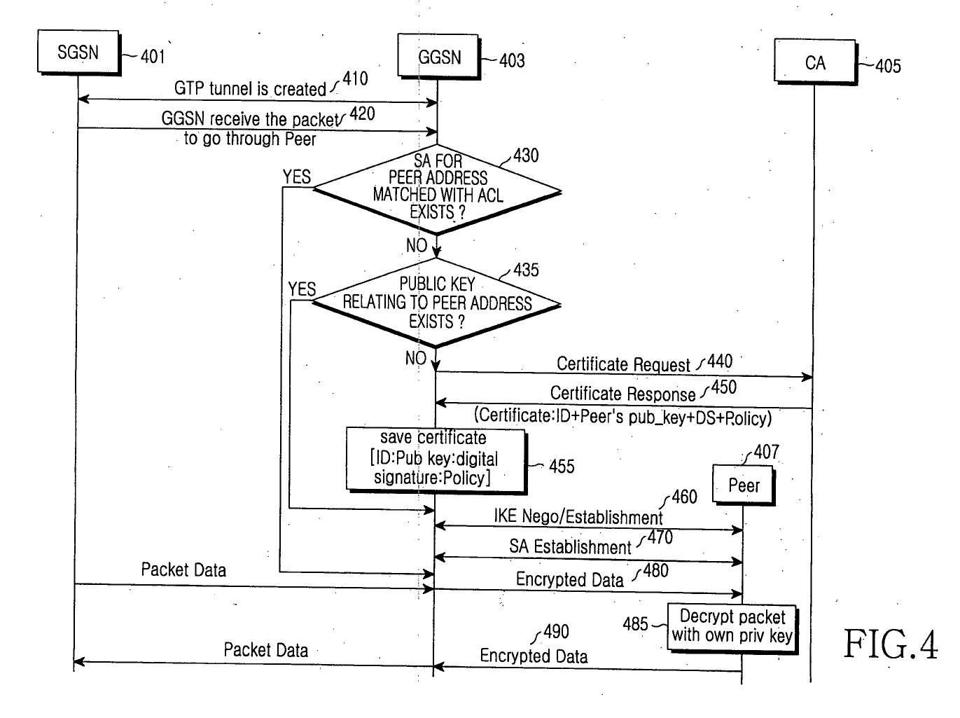

FIG. 4 is a flowchart illustrating an operational procedure in a UMTS network according to a second embodiment of the present invention.

That is, FIG. 4 shows the case in which a GGSN requests a certificate without using a key update function when the GGSN receives a packet filtered based on an ACL.

In the second embodiment shown in FIG. 4, IKE establishment is initiated at the precise moment when packet data received from a mobile node matches the ACL after a GTP tunnel is created. The GGSN 403 determines whether or not SA for a peer exists, and sends a certificate request message if SA for the peer does not exist. A detailed procedure of these operations is as follows:

In the method illustrated in FIG. 4, in step 410, a mobile node initiates a call to create a GTP tunnel between an SGSN 401 and the GGSN 403. The mobile node transmits a packet, which is desired to be transmitted to a peer, to the GGSN 403 through the created tunnel. In step 420, the GGSN 403 determines whether or not a peer address of the packet is included in an ACL, and determines that the packet matches the ACL if the peer address of the packet is included in the ACL. In this case, the packet matching the ACL is buffered in the GGSN 403 so that the packet may be encrypted later.

In step 430, the GGSN 403 determines whether or not SA for the peer address of the packet matching the ACL has been established. If SA for the peer address has been established, the GGSN 403 proceeds to step 480. In contrast, if SA for the peer address has been not established, the GGSN 403 proceeds to step 435, in which the GGSN 403 determines whether or not a public key related to the peer address exists. If a public key related to the peer address exists, step 460 is performed, but if a public key related to the peer address does not exist, the GGSN 403 proceeds to step 440 in which the GGSN 403 sends a certificate request message to a CA 405 in order to obtain a public key for the peer address.

In step 450, upon receiving the certificate request, the CA 405 sends a certificate including information related to a peer public key, an ID, a digital signature, and an IPsec policy to the GGSN 403 by adding the certificate to the certificate response message. In step 455, the GGSN 403, having received the certificate response message, stores the certificate in a security table. In step 460, the GGSN 403 initiates an IKE procedure with the peer 407 by using the public key and IP security policy information stored in the security table. After the IKE procedure is completed, the GGSN 403 establishes SA with the peer 407 in step 470.

In step 480, when the SA establishment has been completed, the GGSN 403 encrypts the buffered packet by means of the public key of the peer, and then sends the encrypted packet to the peer 407. In step 485, the peer 407 decrypts the encrypted packet by means of its own private key. In step 490, in order to send data to the mobile node, the peer 407 encrypts the data by means of the public key of the GGSN 403 stored in a table of the peer 407, and then sends the encrypted data to the GGSN 403. Then, the GGSN 403 decrypts the encrypted data transmitted from the peer 407 by means of its own private key, and transmits the decrypted data through SGSN 401 to the mobile node by means of the GTP tunnel. In this case, when the IKE establishment or SA establishment fails, two processing schemes may be employed as follows.

According to a first scheme, the GGSN sends a message to the mobile node in order to notify the mobile node that it is impossible to access a relevant server. According to a second scheme, the transmission of a packet is stopped and the mobile node cannot access a relevant server, so that the mobile node cannot receive a security service. As a result, after a predetermined time has lapsed, the mobile node stops the attempt to access the relevant server due to a login timeout.

Although FIG. 4 shows a procedure for implementing an embodiment of the present invention in the UMTS network as an example, the present invention is not limited thereto, and can also be implemented in the CDMA2000 network using a PDSN. In the case of the CDMA network, a PPP session is established instead of the creation of a GTP tunnel in step 410, and a PPP session is established between a PDSN and a peer after SA has been established in step 470.

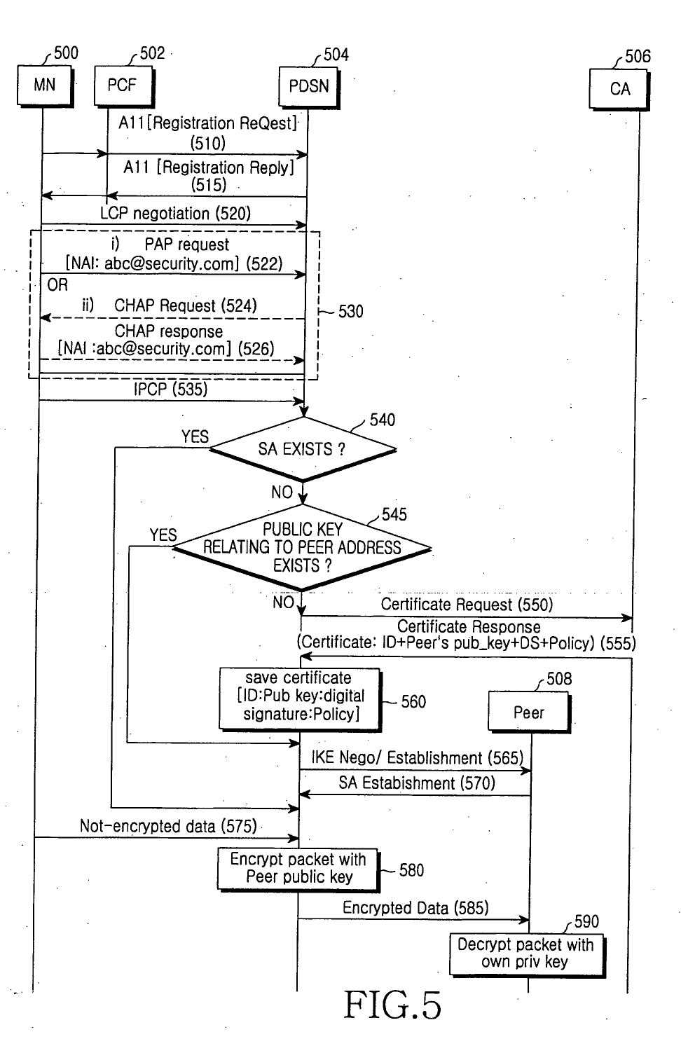

FIG. 5 shows a procedure for applying a PKI to a PDSI in a CDMA core network. In detail, FIG. 5 shows the procedure of a case in which a network access identifier (NAI) is received from a mobile node in a point-to-point protocol (PPP) authentication process after a session between a packet control function (PCF) and a PDSN is established. Unlike the GGSN, the PDSN has no APN, so the “realm (@security.com)” of an NAI uploaded by the mobile node is defined as a security service. In order that a mobile node receives a security service, an authentication procedure is performed in a link control protocol (LCP) after a session between a PCF and a PDSN is established.

The authentication procedure can be performed through a password authentication protocol (PAP) or a challenge handshake authentication protocol (CHAP). The PAP identifies and authenticates remote users. The PAP performs authentication by means of a static password, and provides low level security. The CHAP performs authentication as the PAP, but provides high level security. The CHAP performs authentication by using a challenge/response scheme, and is used by a remote user or router before connection in order to provide an authentication service.

It is determined whether or not there is an NAI carried either with a PAP request message in the authentication procedure using PAP or with a CHAP response message in the authentication procedure using CHAP, and then it is determined whether or not SA exists if an NAI is defined as a security service. If SA for a peer 508 does not exist, a certificate request message is transmitted to a CA.

FIG. 5 is a flowchart illustrating an operational procedure in a CDMA network according to a third embodiment of the present invention.

A detailed procedure for applying PKI will now be described. In the method illustrated in FIG. 5, in order for a mobile node 500 to be provided with a specific security service, a PCF 502 transmits a registration request message for session establishment to a PDSN 504 in step 510. Then, the PDSN 504 transmits a registration response message to the PCF 502 to establish a session in step 515.

In step 520, an LCP negotiation procedure is performed between the mobile node 500 and the PDSN 504, thereby establishing an authentication scheme. Herein, although authentication may be unnecessary, authentication essentially must be performed in order to use a security service. While performing an LCP negotiation procedure with the mobile node 500, the PDSN 504 receives “NAI (abc@security.com)” from the mobile node 500 by means of a predetermined scheme.

After this, there are two cases based on authentication procedures.

In the case of the PAP, the PDSN 504 determines a realm of an NAI in a PAP request message transmitted from the mobile node 500 in step 522. In the case of the CHAP, the PDSN 504 transmits a CHAP request message to the mobile node 500 in step 524, and can determine a realm of an NAI in a CHAP response message transmitted from the mobile node 500 in step 526.

While the PDSN 504 determines a realm of an NAI in step 530, the PDSN 504 obtains an IP through internet protocol control protocol (IPCP) negotiation in step 535. In step 540, the PDSN 504 determines whether or not there is SA for the realm (@security.com) in a received NAI, and proceeds to step 575 if SA for the realm exists. In contrast, if there is no SA for the realm, the PDSN 504 proceeds to step 545, in which the PDSN 504 determines whether or not there is a public key related to a peer address in a pre-stored table. In this case, consistency of the contents (i.e. the public key related to the peer address) stored in a CA 506 and the contents stored in the peer 508 must be guaranteed.

If the public key exists, the PDSN 504 proceeds to step 565. If the public key does not exist, the PDSN 504 proceeds to step 550 to send a certificate request message to the CA 506.

In step 555, the PDSN 504 receives a certificate response message having a certificate, which includes a digital signature, an IPsec policy, an identifier, and a public key of the peer, from the CA 506. In step 560, the PDSN 504 stores the received certificate, which includes information about the digital signature, the IPsec policy, the identifier, and the public key of the peer in a security table.

In step 565, the PDSN 504 initiates an IKE procedure with the peer 508 by using the public key and IP security policy information stored in the security table. After the IKE procedure is finished, the PDSN 504 initiates the SA establishing procedure with the peer 508 in step 570. If the SA establishment fails in step 570, the PDSN 504 sends an LCP termination signal to the mobile node 500 so as to release a PPP session, and then performs registration update so as to release the session established through steps 510 to 515.

When the PDSN 504 receives non-encrypted data from the mobile node 500 in step 575, the PDSN 504 encrypts a packet by means of the public key of the peer 508 stored in the security table in step 580, and then transmits the encrypted packet to the peer 508 in step 585. The peer 508, having received the encrypted packet, decrypts the encrypted packet by means of its own private key in step 590, thereby obtaining data.

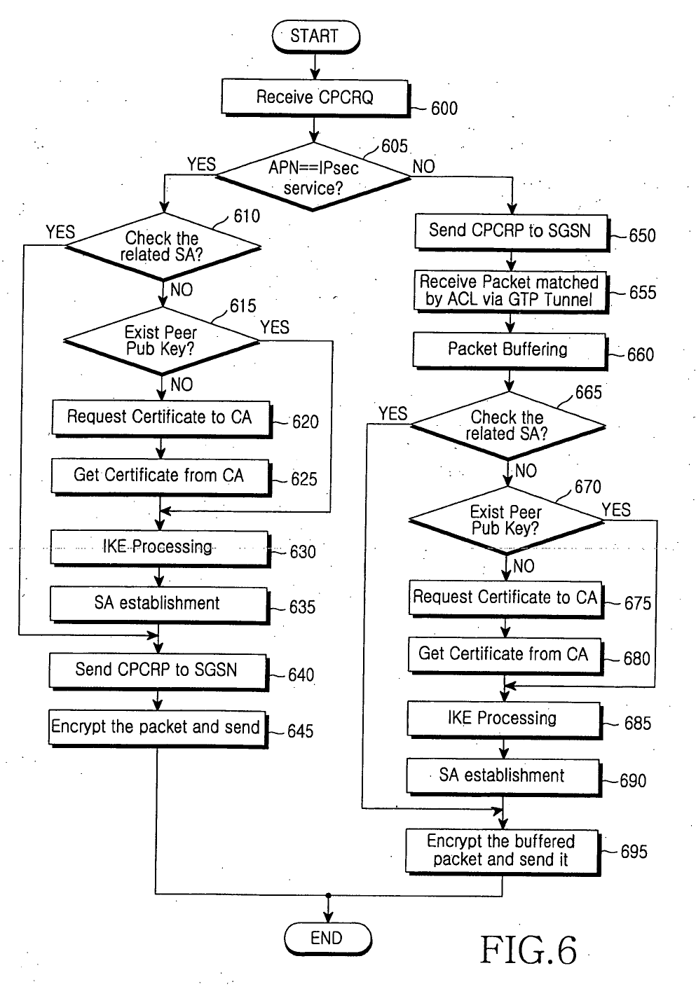

FIG. 6 is a flowchart illustrating the operation of a GGSN according to the first and second embodiments of the present invention.

In the method illustrated in FIG. 6, in step 600, a GGSN receives a CPCRQ including an APN. In step 605, if the APN included in the CPCRQ corresponds to an IPsec service, the GGSN determines whether or not there is SA for the APN in step 610. If SA for the APN exists, the GGSN proceeds to step 640. If there is no SA for the APN, the GGSN proceeds to step 615. In step 615, the GGSN determines whether or not there is a public key for a peer address which matches with the APN included in the CPCRQ. If there is a public key for the peer address, the GGSN proceeds to step 630. If there is no public key for the peer address, the GGSN proceeds to step 620 in which the GGSN transmits a certificate request message to a CA.

When the GGSN receives a certificate response message from the CA in step 625, the GGSN performs an IKE processing procedure with the peer in step 630. After the IKE is finished, the GGSN establishes SA with the peer in step 635. In step 640, the GGSN sends a CPCRP message to an SGSN after the SA is established. In the second embodiment of the present invention, since a CPCRP message is not used, step 645 is performed just after step 635 has been completed.

In step 645, the GGSN receives a packet from a mobile node, encrypts the received packet, and sends the encrypted packet to the peer.

If the APN does not correspond to an IPsec service in step 605, the GGSN proceeds to step 650. In step 650, the GGSN transmits a CPCRP message to the SGSN, and creates a GTP tunnel in cooperation with the SGSN. When the GGSN receives packet data matching an ACL, which has been established for peer addresses, from the mobile node through the GTP tunnel in step 655, the matched packets are sequentially buffered in step 660. When a packet matching the ACL is generated, the GGSN determines whether or not there is SA for a peer address of the packet in step 665. If SA for the peer address exists, the GGSN proceeds to step 695. If there is no SA for the peer address, the GGSN proceeds to step 670. In step 670, the GGSN determines whether or not there is a public key for the peer address.

If a public key for the peer address exists, the GGSN proceeds to step 685. If there is no public key for the peer address, the GGSN proceeds to step 675 in which the GGSN transmits a certificate request message to the CA. When the GGSN receives a certificate response message from the CA in step 680, the GGSN performs an IKE (Internet Key Exchange) procedure with the peer in step 685, and then establishes SA with the peer in step 690. In step 695, the GGSN encrypts the buffered packet and sends the encrypted packet to the peer.

In the case of employing PKI in order to manage a key for an IPsec tunnel, the GGSN includes tables for storing and using information about the GGSN and peers. The tables are divided into a first table for storing information about the GGSN and a second table for storing information about peers.

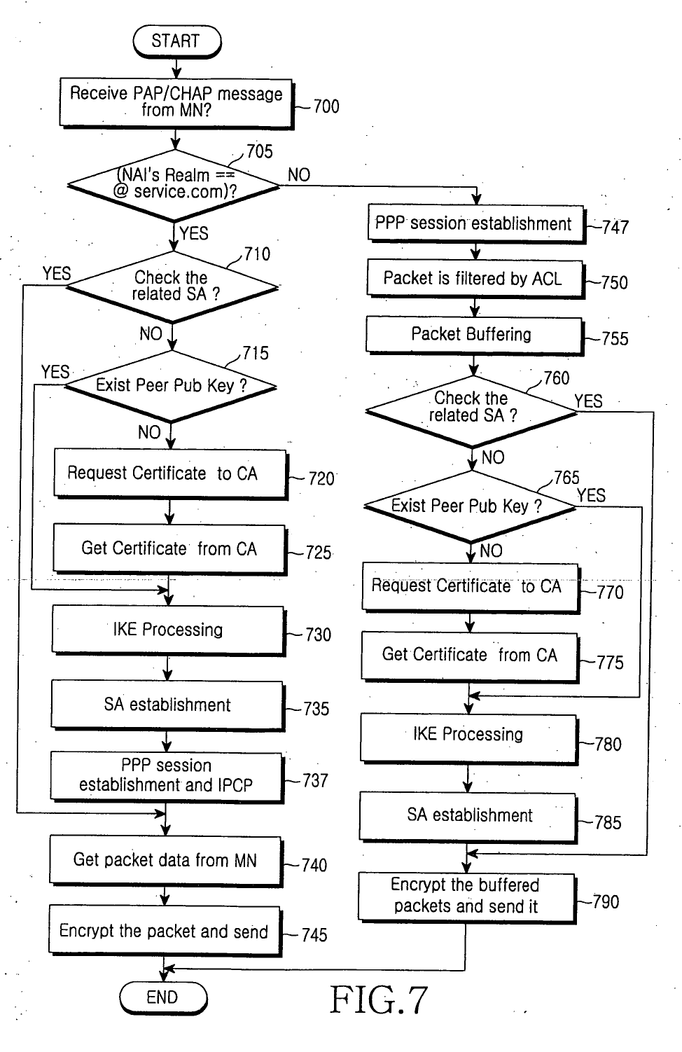

FIG. 7 is a flowchart illustrating the operation of a PDSN according to the third embodiment of the present invention.

In the method illustrated in FIG. 7, in step 700, a PDSN receives a PAP/CHAP message from a mobile node. If the PDSN receives an NAI's realm (@security.com) when it receives the PAP/CHAP message in step 705, the PDSN determines whether or not there is SA for the realm (@security.com) of the NAI in step 710. If SA for the realm exists, the PDSN proceeds to step 740. If there is no SA for the realm, the PDSN proceeds to step 715. In step 715, the PDSN determines whether or not there is a public key for a peer address in a security table stored in the PDSN. If there is a public key for the peer address, the PDSN proceeds to step 730. If there is no public key for the peer address, the PDSN proceeds to step 720 in which the PDSN transmits a certificate request message to a CA.

When the PDSN receives a certificate response message from the CA in step 725, the PDSN performs an IKE processing procedure with the peer in step 730. After the IKE is completed, the PDSN establishes SA with the peer in step 735. In step 737, the PDSN establishes a PPP session, and performs an IPCP negotiation with the peer.

After having established the SA, the PDSN receives packet data from the mobile node in step 740. In step 745, the PDSN encrypts the packet data and sends the encrypted packet data to the peer.

In step 705, if the PDSN does not receive a realm (@security.com) of the NAI, the PDSN proceeds to step 747, in which the PDSN establishes a PPP session with the mobile node. When packet data received from the mobile node through the PPP session matches an ACL established for peer addresses in step 750, the matched packets are sequentially buffered in step 755. When a packet matching the ACL is generated, the PDSN determines whether or not there is SA for a peer address of the packet in step 760. If SA for the peer address exists, the PDSN proceeds to step 790. If there is no SA for the peer address, the PDSN proceeds to step 765. In step 765, the PDSN determines whether or not there is a public key for the peer address.

If a public key for the peer address exists, the PDSN proceeds to step 780, but if there is no public key for the peer address, the PDSN proceeds to step 770 in which the PDSN transmits a certificate request message to the CA. When the PDSN receives a certificate response message from the CA in step 775, the PDSN performs an IKE procedure with the peer in step 780, and then establishes SA with the peer in step 785. In step 790, the PDSN encrypts the buffered packet and sends the encrypted packet to the peer.

In the case of employing PKI in order to manage a key for an IPsec tunnel, the PDSN includes tables for storing and using information about the PDSN and peers. The tables are preferably divided into a first table for storing information about the PDSN and a second table for storing information about peers.

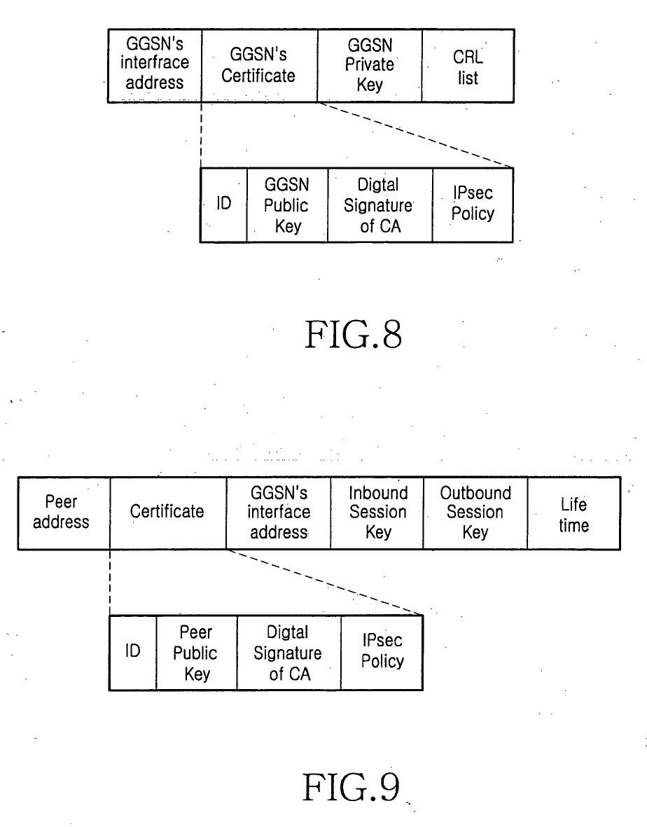

FIG. 8 is a view illustrating an exemplary table related to a GGSN according to an embodiment of the present invention.

The table of FIG. 8 related to a GGSN stores a certificate, a private key and a CRL generated either for each interface of the GGSN or for a single GGSN, in order to enable the GGSN to use PKI. The certificate includes an authentication client's ID, a public key, a digital signature of a CA, and IPsec policy information. The table related to the GGSN receives a certificate of the CA through the certificate request/response procedure. When the GGSN desires to register a new public/private key pair, the GGSN updates the table related to the GGSN, and registers a new public key in the CA through a key update procedure. After the registration is finished, the existing certificate is stored in the CRL for the table related to the GGSN, and a newly-received certificate is stored in the table related to the GGSN.

FIG. 9 is a view illustrating an exemplary table related to peers according to an embodiment of the present invention.

The table of FIG. 9 related to peers is created whenever one SA is established per peer. The table related to peers stores a certificate for each peer authenticated by a CA through an authentication request, a GGSN's interface address, inbound/outbound session keys which are generated when SA has been established, and lifetime information. The certificate includes an authentication client's ID, a public key, a digital signature of the CA, and IPsec policy information. The lifetime comprises information representing effective time of SA, and is preferably determined based on traffic volume and time. When the lifetime elapses, a key update (re-key) procedure is performed. Upon a key update, the inbound/outbound session keys are changed. Similarly, the table related to peers receives a certificate of the CA through the certificate request/response procedure. When receiving a certificate announcement message from the CA, peers search their own security tables for a relevant certificate, and change the relevant certificate.

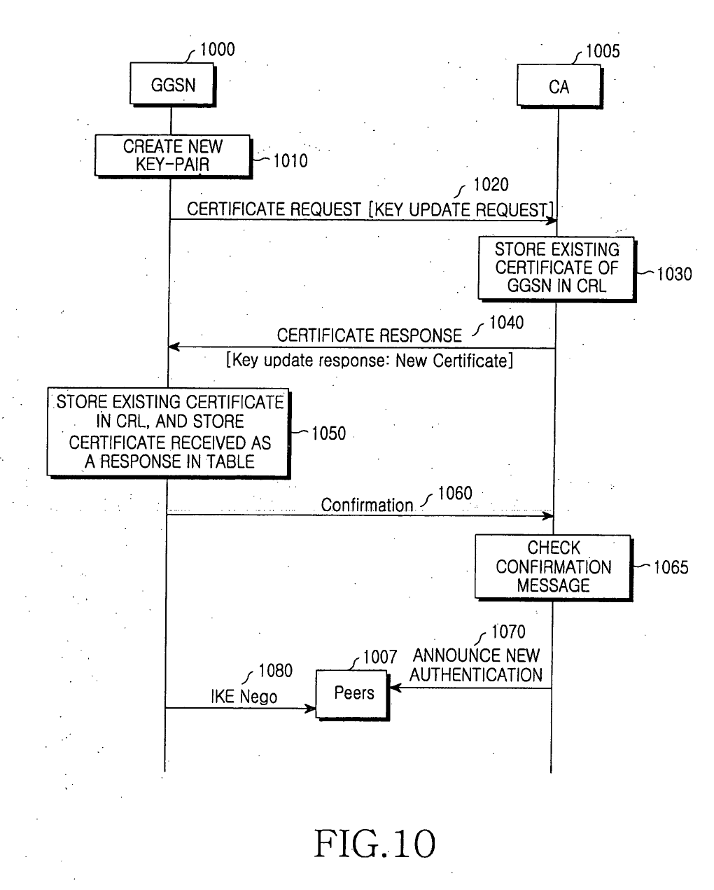

FIG. 10 is a flowchart illustrating a procedure for changing a public/private key by a GGSN according to an embodiment of the present invention.

In the method illustrated in FIG. 10, in step 1010, the GGSN 1000 creates a new key pair containing a public key and a private key in order to change the public/private key. In step 1020, the GGSN 1000 updates its own security table with the new key pair, and sends a certificate request (i.e. key update request) message to a CA 1005 so as to acquire authentication for the new key pair.

In step 1030, the CA 1005, having received the certificate request message, stores the existing certificate for the GGSN in a CRL. In step 1040, the CA 1005 creates a new certificate including the new key pair, and transmits a certificate response message including the new certificate to the GGSN 1000. In step 1050, the GGSN 1000, having received the certificate response message, stores the pre-stored certificate in a CRL for the security table of the GGSN 1000, and stores the new certificate received through the certificate response message in the security table of the GGSN 1000.

In step 1060, the GGSN 1000 creates a confirmation message representing that the certificate response has been processed, and transmits the confirmation message to the CA 1005. In step 1065, the CA 1005 determines the confirmation message received from the GGSN 1000. In step 1070, the CA 1005 broadcasts an authentication message including the new certificate of the GGSN 1000 to peers 1007, which are authentication clients managed by the CA 1005, through a certificate announcement message, thereby guaranteeing the identity of authentication between the CA 1005 and the authentication clients 1007. After transmitting the confirmation message, the GGSN 1000 performs an IKE negotiation procedure with the peers 1007 in step 1080 although the lifetime has not elapsed.

Exemplary effects, benefits and other aspects of embodiments of the present invention, especially the effects obtained by the above-mentioned embodiments, will now be described.

According to embodiments of the present invention, since it is enough if the GGSN/PDSN manages a public/private key pair for each GGSN/PDSN or each interface address of the GGSN/PDSN, the number of keys which the user must manage becomes reduced, as compared with when a PSK scheme is used. In addition, when a key changes, it is enough for the GGSN/PDSN to register its own public key in a CA without changing all keys, so that it is possible to easily manage keys, and security of keys is improved because distribution of key information is not required.

While the present invention has been shown and described with reference to certain exemplary embodiments thereof, it will be understood by those skilled in the art that various changes in form and details may be made therein without departing from the spirit and scope of the present invention as defined by the appended claims. Accordingly, the scope of the present invention is not to be limited by the above embodiments but by the claims and the equivalents thereof.

What is claimed is:

1. A method for security of an IP security tunnel using public key infrastructure in a security gateway of a mobile communication network, the method comprising the steps of:
receiving a request message from a mobile node which relates to a security service requested by the mobile node;
determining if there is security association (SA) for the security service, and determining if there is a public key related to a peer address when the SA does not exist;
sending a certificate request message to a certificate authority (CA) when the public key does not exist, and receiving a certificate response message from the certificate authority which has a certificate that comprises a public key related to the peer address;
performing an internet key exchange and SA establishment procedure with a peer corresponding to the peer address by using the certificate;
completing the internet key exchange and the SA establishment; and
encrypting a packet received from the mobile node by means of the public key, transmitting the encrypted packet to the peer, decrypting a packet received from the peer by means of a private key corresponding to the public key, and transmitting the decrypted packet to the mobile node.

2. The method as claimed in claim 1, wherein the request message comprises a CPCRQ (Create Packet Data Protocol Context Request) message, which includes a specific access point name (APN) related to an IP security service requested by the mobile node.

3. The method as claimed in claim 1, wherein the request message comprises an authentication protocol message, which includes security area information of a network access identifier (NAI) related to the IP security service which is requested by the mobile node in an authentication procedure after a link control protocol (LCP) is established with respect to the mobile node.

4. The method as claimed in claim 3, further comprising a step of:
receiving an IP though internet protocol control protocol (IPCP) negotiation with the mobile node after completing the authentication procedure.

5. The method as claimed in claim 3, wherein the authentication protocol message comprises one message selected from a password authentication protocol (PAP) request message and a challenge handshake authentication protocol (CHAP) response message.

6. The method as claimed in claim 1, further comprising a step of:
transmitting a response message to the mobile node when the SA establishment has been completed.

7. The method as claimed in claim 1, further comprising a step of:
transmitting the response message to the mobile node without delay when the SA exists.

8. The method as claimed in claim 6 or 7, wherein the response message comprises a CPCRP (Create Packet Data Protocol Context Response) message.

9. The method as claimed in claim 1, further comprising a step of:
performing the internet key exchange and SA establishment procedure with the peer without delay when the public key exists.

10. The method as claimed in claim 1, wherein the certificate comprises at least one of a public key of the peer, an identifier (ID), IP security policy, and a digital signature.

11. The method as claimed in claim 1, further comprising a steps of:
performing encryption and decryption of the packets by means of a session key created by the security gateway in the case of using a key update function when the SA establishment has been completed; and
performing a key update procedure when lifetime of the session key elapses.

12. The method as claimed in claim 1, further comprising a step of:
inserting a failure reason value into a cause field of the response message in order to transmit the failure reason value to the mobile node when the SA establishment fails.

13. The method as claimed in claim 1, further comprising a step of:
transmitting a message comprising information notifying the mobile node of restriction to access a server to the mobile node when the SA establishment fails, or stopping provision of the security service after a predetermined period of time has lapsed when the SA establishment fails.

14. A method for security of an IP security tunnel using public key infrastructure in a security gateway of a mobile communication network, the method comprising the steps of:
creating a tunnel in cooperation with a service node providing a service to a mobile node, and receiving a packet having a security-required peer address through the created tunnel;
buffering the received packet, and determining if security association (SA) for the security-required peer address has been established;
determining if there is a public key related to the peer address when the SA does not exist;
sending a certificate request message to a certificate authority (CA) when the public key does not exist, and receiving a certificate response message which has a certificate comprising a public key related to the peer address from the certificate authority;
performing an internet key exchange and SA establishment procedure with a peer corresponding to the peer address by using the certificate; and
encrypting a packet received from the mobile node by means of the public key to transmit the encrypted packet to the peer when the internet key exchange and the SA establishment are completed, and decrypting a packet received from the peer by means of a private key corresponding to the public key to transmit the decrypted packet to the mobile node.

15. The method as claimed in claim 14, further comprising a step of:
performing the internet key exchange and SA establishment procedure with the peer without delay when the public key exists.

16. The method as claimed in claim 14, wherein the certificate comprises at least one of a public key of the peer, an identifier (ID), IP security policy, and a digital signature.

17. The method as claimed in claim 14, further comprising a steps of:
performing encryption and decryption of the packets by means of a session key created by the security gateway in the case of using a key update function when the SA establishment has been completed; and
performing a key update procedure when lifetime of the session key elapses.

18. A method for security of an IP security tunnel using public key infrastructure in a mobile communication network, the method comprising the steps of:
creating, by a security gateway for a mobile node, a new key pair containing a public key and a private key in order to change public/private keys used to communicate with the mobile node and a peer, and sending a key update request message including the new key pair to a certificate authority;
storing, by the certificate authority, an existing certificate of the security gateway in a certification revocation list, creating a certificate response message having a new certificate including the new key pair, and transmitting the certificate response message to the security gateway;
storing, by the security gateway, a pre-stored certificate in a certification revocation list of the security gateway, storing the new certificate, and transmitting a confirmation message to the certificate authority; and
broadcasting, by the certificate authority, a certificate announcement message including the new certificate to authentication clients which are managed by the certificate authority in response to the confirmation message.

19. The method as claimed in claim 18, further comprising a step of:
performing, by the security gateway, internet key negotiation with the peers after the confirmation message is transmitted.

20. The method as claimed in claim 18, further comprising a step of:
managing, by the security gateway, a security gateway-relation table which comprises at least one of the certificate, the private key, and the certification revocation list.

21. The method as claimed in claim 20, wherein the certificate for each security gateway comprises at least one of an interface ID, a public key of the security gateway, a digital signature, and IP security policy.

22. The method as claimed in claim 18, further comprising a step of:
managing, by the security gateway, a peer-relation table which comprises at least one of a certificate for each peer, an interface address of the security gateway, an inbound/outbound session key, and lifetime of the session key.

23. The method as claimed in claim 22, wherein the certificate for each peer comprises at least one of a peer ID, a peer's public key, a digital signature, and IP security policy.

24. An apparatus for security of an IP security tunnel using public key infrastructure in a security gateway of a mobile communication network, the apparatus comprising:
a mobile node for generating a request message related to a security service to transmit the request message to the security gateway, and transmitting/receiving packet data;
the security gateway for determining if there is security association (SA) for the security service, determining if there is a public key related to a peer address when the SA does not exist, sending a certificate request message to a certificate authority (CA) when the public key does not exist, receiving a certificate response message which has a certificate including a public key related to the peer address from the certificate authority, performing an internet key exchange and SA establishment procedure with a peer corresponding to the peer address by using the certificate, encrypting a packet received from the mobile node by means of the public key, transmitting the encrypted packet to the peer when the internet key exchange and the SA establishment has been completed, decrypting a packet received from the peer by means of a private key corresponding to the public key, and transmitting the decrypted packet to the mobile node; and
the certificate authority for transmitting a certificate response message, which has the certificate including the public key related to the peer address, to the security gateway when the certificate request message is received from the security gateway.

25. The apparatus as claimed in claim 24, wherein the mobile node is configured to create a tunnel in cooperation with the security gateway and transmit a packet having a security-required peer address to the security gateway through the created tunnel.

26. The apparatus as claimed in claim 25, wherein the security gateway is configured to buffer the received packet and determine if SA for the security-required peer address has been established.

27. The apparatus as claimed in claim 24, wherein the request message comprises a CPCRQ (Create Packet Data Protocol Context Request) message, which comprises a specific access point name (APN) related to an IP security service requested by the mobile node.

28. The apparatus as claimed in claim 24, wherein the request message comprises an authentication protocol message, which includes security area information of a network access identifier (NAI) related to the IP security service that is requested by the mobile node in an authentication procedure after a link control protocol (LCP) is established with respect to the mobile node.

29. The apparatus as claimed in claim 28, wherein the security gateway is configured to receive an IP though internet protocol control protocol (IPCP) negotiation with the mobile node after completing the authentication procedure.

30. The apparatus as claimed in claim 28, wherein the authentication protocol message comprises one message selected from a password authentication protocol (PAP) request message and a challenge handshake authentication protocol (CHAP) response message.

31. The apparatus as claimed in claim 28, wherein the security gateway is configured to transmit a response message to the mobile node when the SA establishment has been completed.

32. The apparatus as claimed in claim 24, wherein the security gateway is configured to transmit the response message to the mobile node without delay when the SA exists.

33. The apparatus as claimed in claim 31 or 32, wherein the response message comprises a CPCRP (Create Packet Data Protocol Context Response) message.

34. The apparatus as claimed in claim 24, wherein the security gateway is configured to perform the internet key exchange and SA establishment procedure with the peer without delay when the public key exists.

35. The apparatus as claimed in claim 24, wherein the certificate comprises at least one of a public key of the peer, an identifier (ID), IP security policy, and a digital signature.

36. The apparatus as claimed in claim 24, wherein, when the SA establishment has been completed, the security gateway is configured to:
perform encryption and decryption of the packets by means of a session key created by the security gateway in the case of using a key update function; and
perform a key update procedure when lifetime of the session key elapses.

37. The apparatus as claimed in claim 24, wherein, when the SA establishment fails, the security gateway is configured to insert a failure reason value into a cause field of the response message and transmit the response message to the mobile node.

38. The apparatus as claimed in claim 24, wherein, when the SA establishment fails, the security gateway is configured to transmit a message including information notifying the mobile node of restriction to access a server to the mobile node, or stop provision of the security service after a predetermined period of time has lapsed.

39. The apparatus as claimed in claim 24, wherein the key update procedure is performed by the security gateway and the certificate authority, wherein
the security gateway is configured to create a new key pair containing a public key and a private key in order to change public/private keys used to communicate with the mobile node and a peer, send a key update request message including the new key pair to a certificate authority, store a pre-stored certificate in a certification revocation list of the security gateway according to response of the certificate authority, store the new certificate, and then transmit a confirmation message to the certificate authority; and
the certificate authority is configured to store an existing certificate of the security gateway in a certification revocation list, create a certificate response message having a new certificate including the new key pair, transmit the certificate response message to the security gateway, and broadcast a certificate announcement message including the new certificate to authentication clients managed by the certificate authority.

40. The apparatus as claimed in claim 39, wherein the security gateway is configured to perform internet key negotiation with the peers after the confirmation message is transmitted.

41. The apparatus as claimed in claim 39, wherein the security gateway is configured to manage a security gateway-relation table which comprises at least one of the certificate, the private key, and the certification revocation list.

42. The apparatus as claimed in claim 41, wherein the certificate for each security gateway comprises at least one of an interface ID, a public key of the security gateway, a digital signature, and IP security policy.

43. The apparatus as claimed in claim 39, wherein the security gateway is configured to manage a peer-relation table which comprises at least one of a certificate for each peer, an interface address of the security gateway, an inbound/outbound session key, and lifetime of the session key.

44. The apparatus as claimed in claim 43, wherein the certificate for each peer comprises at least one of a peer ID, a peer's public key, a digital signature, and IP security policy.
